(19) United States
(12) Patent Application Publication
(10) Pub. No.: US 2026/0205638 A1
(43) Pub. Date: Jul. 16, 2026

(54) SYSTEMS AND METHODS FOR CONTENT INTERFERENCE

(71) Applicant: Comcast Cable Communications, LLC, Philadelphia, PA (US)

(72) Inventors: Matthew EBERSVILLER, EVERGREEN, CO (US); Ryan MCMURRAY, ARVADA, CO (US); Jonathan KIRKOVICH, PARKER, CO (US)

(21) Appl. No.: 19/016,928

(22) Filed: Jan. 10, 2025

(51) Int. Cl. H04N 21/233; H04N 21/2383; H04N 21/258

(52) U.S. Cl. CPC H04N 21/233; H04N 21/2383; H04N 21/25816

(57) ABSTRACT

Methods and systems are described for preventing piracy of content. Content may be encoded with a human audible interference audio. The interference audio may make it difficult for a human to understand the content, while still allowing output of the content. To remove the interference audio, a user device may determine a location of the interference audio within the content, use a key to demodulate the content, and/or have information indicating the content of the interference audio.

### BACKGROUND

Content distribution has improved with the digitization of modern content. This has allowed content distribution platforms to provide content for streaming via the internet through a variety of services to a large variety of devices. However, the digitization of content may allow people to steal or share the content with unauthorized users or share content with unauthorized devices. Thus, there is a need for more sophisticated techniques for preventing content from being shared with unauthorized devices.

### SUMMARY

Methods and systems for interfering with content items are disclosed. The disclosed techniques relate to interfering with content items, such as interfering with content to prevent unauthorized sharing and stealing (e.g., piracy) of content. Interference may include impairing and/or otherwise interfering with the audio for non-authorized users while allowing authorized users to enjoy the content without interference. A computing device associated with a content provider may receive content, which may include both audio and video portions. The computing device may identify specific locations within the audio portion to insert interference audio. This interference audio may interfere with at least a portion of the content. The interference audio may disrupt the user's ability to hear at least a portion of the content. The modified content, comprising the interference audio, may be sent to a user device requesting the content along with a key to decode, demodulate, and/or otherwise remove the interference audio. If the user device has authorization to access the content, the user device may be able to determine the correct locations (e.g., using a predetermined location process, or otherwise) of the interference audio and remove the interference audio before output using the key. Unauthorized users who may gain access to the content but do not have the key may be unable to remove the interference audio.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an example system.

FIG. 2 shows an example audio portion of content.

FIG. 3 shows an example method.

FIG. 4 shows an example method.

FIG. 5 shows an example method.

FIG. 6 is a block diagram illustrating an example computing device.

### DETAILED DESCRIPTION OF ILLUSTRATIVE EMBODIMENTS

Content streaming has become a popular way for users to view content. Content providers may grant access to content via subscriptions or the like. Users may purchase access to content by subscribing or purchasing access to individual content items. However, some users may abuse access to the content and share with unauthorized people. In some scenarios, content may also be stolen from content providers networks or services. This may be a costly problem to content providers. As such, it may be beneficial for content providers to have a method or system to prevent sharing of content with unauthorized devices. The present disclosure relates to systems and methods for inserting undesirable audio into content audio. The content may comprise an audio portion and a video portion. In some examples, the audio portion, a location, and an additional location may be determined. The location may define a first sample position in a first sampling set and the additional location may define a second sample position within a second sampling set. The determination of the location and the additional location may cause interference audio to be inserted at the first sample position and the second sample position of the audio portion of content. The content comprising the interference audio may be sent to one or more user devices requesting the content. Additionally, a key may be sent. The key may configure a device to decode, demodulate, and/or remove the interference audio such that authorized devices may listen to the audio associated with the content without interference. The key may be sent to devices that are determined to be authorized.

By way of further explanation, the disclosed techniques may comprise modulation audio signals based on an arbitrary audio waveform shifted by sample timing. For a 48 KHz audio sample rate, an encrypted, number (e.g., a large prime number) may be sent to a user device which may use the number as modulus to modulate every n seconds (e.g., where n may be a predetermined interval variable between sender and receiver of the content). The content provider may send a new, encrypted number (e.g., prime number) at a regular predetermined interval which may become the new audio “key” that user device uses to decrypt the incoming audio content. The information required to decrypt the audio may comprise any combination of the following:
1. An interference (e.g., arbitrary/random) audio waveform (e.g., new/updated waveform can be sent at a predetermined interval).
2. A number (e.g., large prime number) to demodulate the audio waveform
3. The location(s) (e.g., shift interval, or sampling index in a sample window) at which the large prime number demodulates the interference audio waveform.

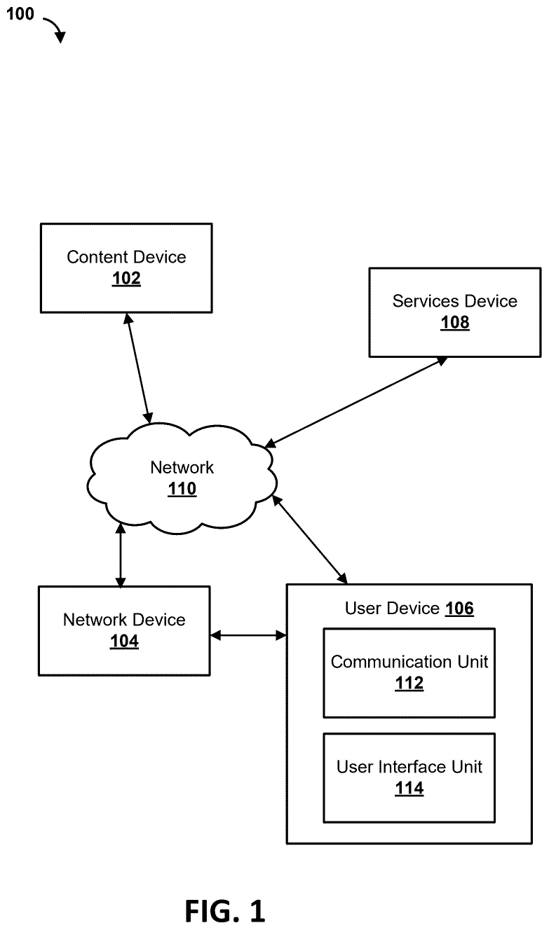

FIG. 1 shows a block diagram of an example system 100. The system 100 may be capable of facilitating communications among devices or provisioning of content among devices. The system 100 may comprise a network device 104 (e.g., gateway device, router, or combination thereof), a user device 106, a services device 108 (e.g., an application device, application server), or a combination thereof. The system 100 may further comprise a content device (e.g., content server, edge device). The content device 102, the network device 104, the user device 106, and/or the services device 108 may each be implemented as one or more computing devices. Any device disclosed herein may be implemented using one or more computing nodes, such as virtual machines, executed on a single device and/or multiple devices.

The content device 102, the network device 104, the user device 106, and/or the service device 108 may be communicatively coupled via one or more networks, such as network 110 (e.g., a wide area network). The network 110 may comprise a content distribution and/or access network. The network 110 may facilitate communication via one or more communication protocols. The network 110 may comprise fiber, cable, a combination thereof. The network 110 may comprise wired links, wireless links, a combination thereof, and/or the like. The network 110 may comprise routers, switches, nodes, gateways, servers, modems, and/or the like.

The services device 108 may be configured to provide one or more services, such as account services, application services, network services, content services, or a combination thereof. The services device 108 may comprise services for one or more applications on the user device 106. The services device 108 may generate application data associated with the one or more application services. The application data may comprise data for a user interface, data to update a user interface, data for an application session associated with the user device 106, and/or the like.

The services device 108 may be configured to determine to send information (e.g., configuration settings, notifications, information about the premises) to the user device 106, the network device 104, or a combination thereof. One or more content devices 102, 105 may comprise information rules associating various values, patterns, account information, and/or the like with corresponding information. The information may be sent to the user device 106 based on the information rule being triggered and/or satisfied. The information may comprise a configuration setting of the network device 104 and/or the user device 106.

In some scenarios, the services device 108 may provide data for a user interface, such as a content browser for accessing content from the content device 102. The content device (e.g., or services device) 108 may be configured to insert interference audio into content. Interference audio may comprise unwanted or disruptive sound inserted into an audio portion of content. The interference audio may be intentionally inserted as unwanted or disruptive sound into the audio portion of content. This interference audio may be used to protect content from unauthorized access and sharing. The interference audio may be embedded within the original audio track in such a way that the interference audio can only be removed with a specific key and/or code provided to authorized users. A location of where the interference audio is embedded may also be used to remove the interference audio. The location of where the interference audio is embedded may only be shared with user's authorized to access specific content. This process helps ensure that only those with proper authorization can enjoy the content without the interference audio, while those without authorization will hear the interference, making the content less enjoyable or even unwatchable.

The content device 102 may be configured to insert interference audio into content upon various triggers, such as a user's request for content, during an encoding process, or a determination that a user is deemed untrustworthy. For example, the content device 102 may insert interference audio into content when the content is prone to piracy. The process may begin by determining a sampling set, which may comprise (e.g., or consist) of all audio samples within a given time range, such as 44,100 samples per second. Within this sampling set, the content device 102 may determine specific sampling locations, such as the nth sample in the set, where the interference audio will be inserted. The nth number may be a number determined within the sampling set. A key may also be used to modulate the interference audio at the determined locations, ensuring that only authorized devices can decode and remove the interference audio. This interference audio may be inserted at multiple locations within a single sampling set or at different locations across various sampling sets, making unauthorized access and sharing significantly more challenging.

To facilitate the removal of interference audio, the content device 102 (e.g., other device, such as services device 108) may communicate the necessary information to authorized user devices through secure channels. This information may comprise the specific locations within the audio sampling sets where the interference audio has been inserted, the key required to demodulate and remove the interference audio, and/or the like. The key and location(s) may be encrypted. The key and location(s) may be sent at regular intervals to authorized user devices (e.g., ensuring that only authorized devices, which can decrypt and understand this information, are able to access and enjoy the content without disruption). In some scenarios, the key (e.g., or information to remove the inference audio) may comprise an indication of the location in the sampling set of where the interference audio begins, an indication of where a sampling set begins, an indication of the waveform of the interface audio (e.g., or the waveform itself), or a combination thereof. For example, the key may be the combination of both the location and the indication of the wave form.

The user device 106 may comprise a computing device, a smart device (e.g., smart glasses, smart watch, smart phone), a mobile device, a tablet, a computing station, a laptop, a digital streaming device, a set-top box, a streaming stick, a television, and/or the like. In some scenarios, a user may have multiple user devices, such as a mobile phone, a smart watch, smart glasses, a combination thereof, and/or the like. The user device 106 may be configured to communicate with one or more content devices (e.g., a content device 102), the network device 104, and/or the like. The user device 106 may be configured to output a user interface. The user interface (e.g., user interface unit 114) may be output via the user interface via an application, service, and/or the like, such as a content browser. The user interface may receive application data from the services device 108. The application data may be processed by the user device 106 to cause display of the user interface.

The user interface may be displayed on a display of the user device 106 (e.g., or controlled by the user device 106). The display may comprise a television, screen, monitor, projector, and/or the like. The user interface may comprise a content management application (e.g., for accessing video, audio, gaming, and/or other media), a smart assistant application, a virtual assistant application, a premises security application, network services application, or a combination thereof. The user interface may be configured to output content via a content browser. The user interface may be configured to provide a plurality of channels (e.g., video channels), streams, video on demand items, audio items, and/or the like. The user interface may be configured to allow a user to configure settings associated with the network device 104.

The user device 106 may be configured to receive encoded content 107 comprising interference audio 109 from one or more content devices (e.g., a content device 102), the network device 104, and/or the like. The user device 106 may be configured to receive a key associated with demodulating interference audio from one or more content devices (e.g., a content device 102), the network device 104, and/or the like. The user device 106 may utilize the key to demodulate interference audio associated with the encoded content. The interference audio may be located at a plurality of locations associated with the audio portion of the encoded content. The user device 106 may utilize the key based on a determination of authorization associated with the user device 106. When the user device 106 is determined to be authorized to access the content, the user device 106 may utilize the key to demodulate the encoded content, such that the user device 106 may output the content, via user interface, without interference audio. Conversely, when the user device 106 is determined to not have authorized access to the encoded content, the user device 106 may not utilize or may not receive the key. In such scenarios, the user device 106 may output the encoded audio, via user interface, where a user may hear the interference audio with output of the content (e.g., encoded content).

The network device 104 may comprise a computing device, a gateway device, an access point (e.g., wireless access point), a router, a modem, device controller (e.g., automation controller, security controller, premises health controller, content device controller) a combination thereof, and/or the like. The network device 104 may be configured to communicate using network 110. The network device 104 may be configured to implement one or more services associated with the services device 108, such as a content service, a premises service, a voice-controlled service, an automation service, a security service, a health monitoring service, or a combination thereof.

The services device 108 may be configured to determine content, such as a content item comprising a plurality of frames. The content item may be determined (e.g., accessed, located) based on a request from a user device 106. The content item may comprise an audio portion and a video portion. Services device 108 (e.g., or content device 102) may comprise one or more of a conditioning device, a transcoder, a packager, or the like to prepare a content item for user consumption via a user device 106. The services device 108 (e.g., or content device 102) may be configured to generate encoded content comprising interference audio mixed with the audio portion of content. The content may comprise interference audio inserted into the original audio portion based on a determined location and/or additional location. The location and/or the additional location may comprise a sample position in an audio sampling set. The location may comprise a first sample position in a first sampling set. The additional location may comprise a second sample position in a second sampling set. The services device 108 may be configured to insert interference audio in the location (e.g., and the additional location) associated with the audio portion of the content, thus making the encoded content. The services device 108 (e.g., or content device 102) may be configured to determine and send a key associated with the interference audio. The key may be sent to a network device when a device is determined to have authorized access to the content. The key may not be sent to network devices that do not have authorized access to the content. The key may contain information, code, or the like such that the interference audio may be removed based on the determined authorization associated with the content requested. The services device 108 (e.g., or content device 102) may be configured to send the encoded content and the key for removing the interference audio to any suitable network device.

The services device 108 (e.g., or content device 102) may be configured to send the content comprising interference audio. The content comprising interference audio (e.g., encoded content) may be sent to the user device 106. The user device 106 may receive encoded content from the content device 102 and/or the network device 104. The user device 106 may determine if it is authorized to access the content. If authorized, the user device 106 needs to know the location of the interference audio. The user device 106 may access local storage (e.g., such as a variable) to determine the location. The user device 106 may use a predetermined process (e.g., pre-agreed upon protocol or algorithm) to determine the location. Once it has the location, the user device 106 can use a key to demodulate (e.g., remove) the interference audio from the encoded content. The key may help the user device 106 to demodulate the interference audio. The user device 106 may then output the content without interference audio. If the user device 106 is unable to determine the location, it may not remove the interference audio. If the user device 106 is not authorized, it may not use or receive the key. In such cases, the user device 106 may output the content with the interference audio. The interference audio may be heard during output of the content. The interference audio may comprise human audible audio that may interfere with a user hearing at least a portion of the audio portion of content. It is contemplated that system 100 may be configured to perform the functions of the forgoing paragraphs for a plurality of devices accessing content.

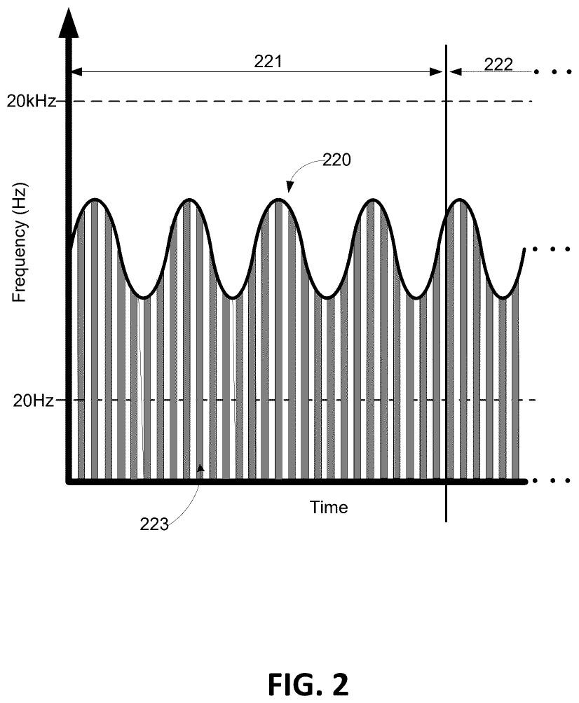

FIG. 2 shows interference audio at a plurality of locations associated with an audio signal (e.g., content 220). For purposes of illustration, FIG. 2 shows as a frequency versus time graph with a simple audio signal, but the actual audio signal will likely be much more complex. The audio may be subdivided into a plurality of sampling sets (e.g., or sample sequencies, such as a first sampling set 221 and a second sampling set 222 associated with the content 220. A sampling set (e.g., first sampling set 221 or second sampling set 222) may comprise the entire set of samples for a given time period. For example, for a 44,100 Hz sampling rate, the entire set of samples can comprise 44,100 samples. Each of the samples may have the same sample period (e.g., or time length of the sample). Each of the 44,100 samples for a given sampling set may be associated with a corresponding sample location (e.g., or sample index). For example, the 10^{th} location may be the tenth sample in a sampling set. As such, a first sample location 223 may be at the nth sample (e.g., any arbitrary number) in the first sampling set 221. The first sample location 223 may indicate a location of where the interference audio is located (e.g., inserted). The location of the first sample location 223 may be different from one content session to another, from one segment to another, from one user to another, and/or the like. The location of the first sample location may be changed periodically. The location may be determined based on an algorithm, selected at random, and/or the like. The location may be communicated from the content provider to a user device, so that the user device may remove the interference audio. It is contemplated that the content 222 may be of any suitable sampling rate, such as but not limited to, 16 kHz, 88.2 kHz, 96 kHz, 192 kHz, or the like. A sample set associated with the sampling rate may be any suitable time period associated with the audio portion of content 222, for example, a sample set may begin at the first tick of a second in nominal playtime of content 222, the beginning of a (or each) frame (e.g., audio frame, video frame) associated with content 222, a randomly chosen point in the audio portion of the content, or any other suitable time period. The sample set may cycle back to zero after counting up to highest sample index defined by the sampling rate (e.g., following the time period of associated with the sample set, the sampling set may repeat continuously for the rate of the sampling rate). In some scenarios, a key associated with demodulating (e.g., decoding) the interference audio may include information associated with the sample set. In some scenarios, the information associated with the sample set may be transmitted separately from the key associated with the interference audio. In a scenario, information associated with the sample set may be a marker (e.g., metadata) in the audio portion of the content 222 or comprised in the key associated with the interference audio.

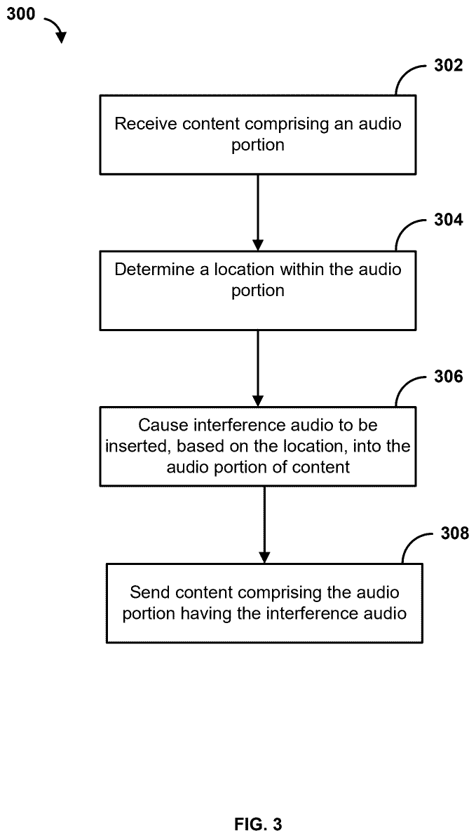

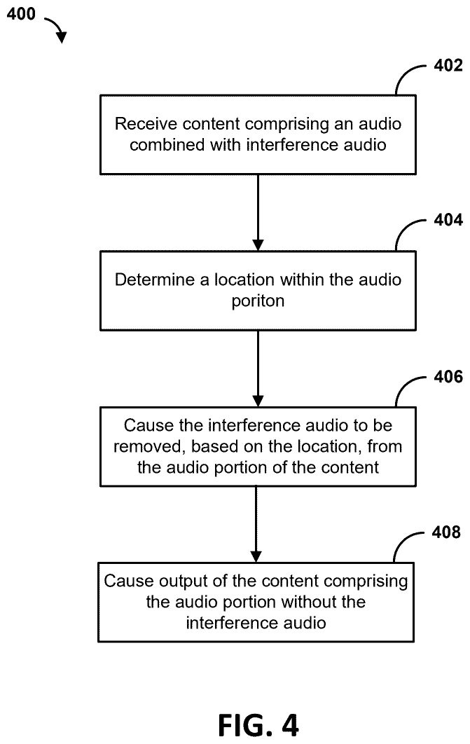

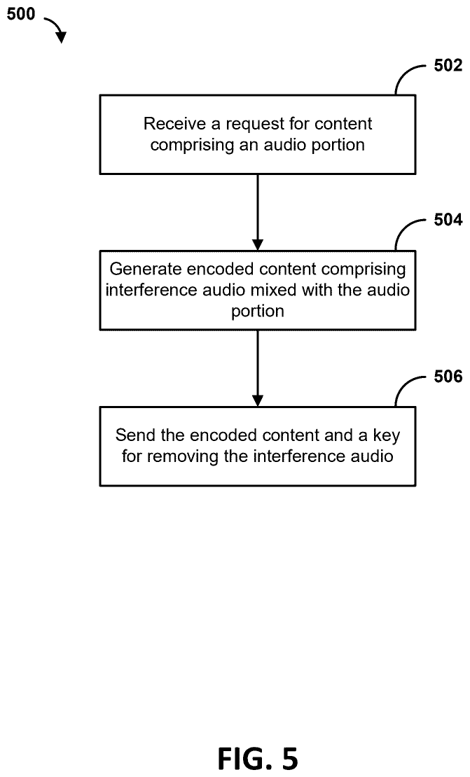

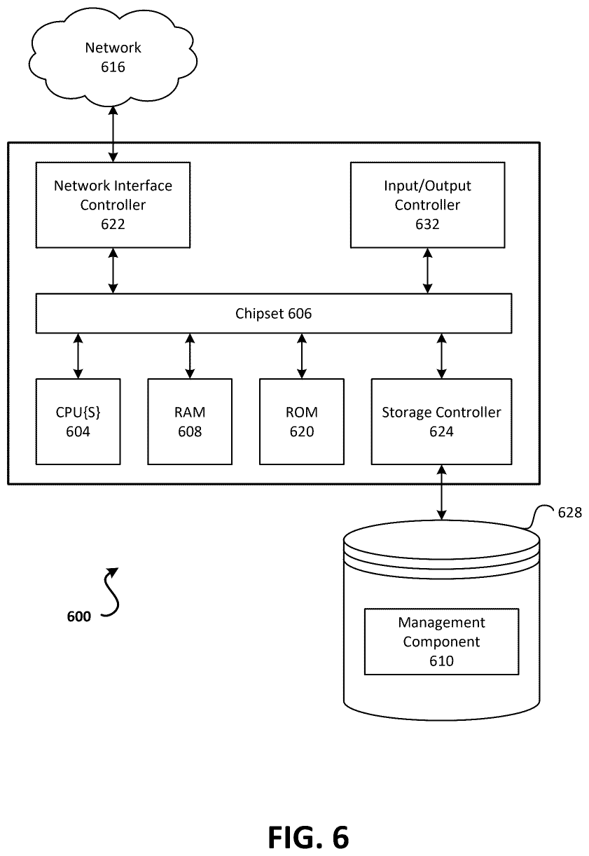

FIG. 3 shows an example method. The method 300 may comprise a computer implemented method for providing a service (e.g., a content service, a network service, a communication service, or a combination thereof). A system and/or computing environment, such as the system 100 of FIG. 1, and/or the computing environment of FIG. 6, may be configured to perform the method 300. The method 300 may be performed in connection with the system illustrated in FIG. 1. Any step or combination of steps of the method 300 may be performed by a computing device, network device, network node, and/or client device, such as any of the devices shown in FIG. 1. Any of the features of the methods of FIG. 4 and FIG. 5 may be combined with any of the features and/or steps of the method 300 of FIG. 3.

At step 302, content may be received. The content may comprise an audio portion. The content may be determined based on a request from a user device associated with a user account. The content may comprise a video portion, audio portion, or a combination thereof. The video portion may comprise a plurality of frames associated with the content. The audio portion may comprise a plurality of audio signals. The user device may be configured to send the request to a computing device, network device, network node, and/or client device, such as any of the devices illustrated in FIG. 1, to receive the content.

At step 304, a location within the audio portion may be determined. The location may comprise a first sample position in a first audio sampling set (e.g., or sequence). An additional location may be determined. The additional location may comprise a second sample position in a second audio sampling set. The audio sampling set may comprise all the audio samples for a given time range. For example, if there are 44,100 samples in a time period (e.g., a second), the sampling set may refer to the set of all 44,100 samples. The location may be a number that indicates which sample is referred to (e.g., or where the sample is located), where an index value may be used to reference any specific audio sample position. For example, the 10^{th} location may refer to the location of the tenth sample in the sampling set.

At step 306, interference audio may be inserted into the audio portion of the content. The insertion of the interference audio may be caused based on the determination of the location. The interference audio may comprise human audible audio that interferes with at least a portion of the audio portion associated with the content. For example, the interference audio may comprise human audible audio that interferes with a user hearing at least the portion of the audio portion associated with the content. The interference audio may be inserted into the audio portion at a first sample position in a first audio sampling set. The first sample position may be indicated by the location determined at step 304. Further, at step 306, additional interference audio may be inserted into the audio portion of the content. The insertion of the additional interference audio may be caused based on the determination of the additional location. The additional interference audio may be different than the interference audio. The additional interference audio may be inserted into a second section of the audio portion at a second sample position in a second audio sampling set.

At step 308, the content comprising the audio portion having the interference audio may be sent. The content comprising the audio portion and the interference audio may be sent to a user device. The user device may be configured to remove the interference audio before output of the content based on authorization to access the content. One or more of the interference audio or an indication of the interference audio may be sent to the user device. Sending the content comprising the audio portion and the interference audio may include sending one or more of: data comprising an indication of the location, or a key for demodulating the interference audio.

A user, associated with a user account may utilize a device (e.g., user device 106) to request to watch a movie (e.g., content) associated with a server device (e.g., services device 108). The server device may communicate with a content device (e.g., content device 102), via a network (e.g., network 110), to receive the content. The server device (e.g., services device 108) may determine a location within the audio portion associated with the movie. The location determined may comprise a first sample position in a first audio sampling set. The server device may also determine an additional location within the audio portion associated with the movie. The additional location may comprise a second sample position in a second audio sampling set.

In response to determining the location, an interference audio may be inserted into the audio portion of the movie (e.g., content). The interference audio may be an audio signal corresponding to incoherent audio within a human audible range. The human audible range may be any audio frequency between 20 Hertz (Hz) and 20 kilohertz (kHz). The interference audio may be inserted into the audio portion of the movie in a first sampling set. In an example scenario, 30 minutes of interference audio may be inserted into the audio portion of the movie at a first sampling position. Additionally, in response to determining an additional location, an additional interference audio may be inserted into the audio portion of the movie. The additional interference audio may comprise incoherent audio within the human audible range. The additional interference audio may be inserted into the audio portion of the movie in a second audio sampling set at a second sampling position. The second sampling set may be associated with the additional location. As such, at least a portion of the audio associated with movie may comprise the additional interference audio. In some scenarios, the movie may contain both the interference audio and the additional interference audio.

The movie (e.g., content) may be sent to a user device (e.g., user device 106) in response to inserting one or more of the interference audio or the additional interference audio to an audio portion of content. The movie may comprise an audio portion and a video portion. The audio portion associated with the movie may comprise the interference audio and/or the additional interference audio. The user device may be configured to determine whether the user device is authorized to access the movie received based on a user account associated with the user device. Based on the determined authorization of the received movie, the interference audio or the additional interference audio may be removed before output of the movie. The interference audio or additional interference audio may be removed based on the user device having authorization to view the movie. Conversely, when the authorization may indicate that the user device does not have access to the movie, the movie may be outputted on the user device comprising the interference audio or the additional interference audio. The movie may comprise one or more of: data comprising an indication of the location and/or the additional location, or a key for demodulating the interference audio. Demodulating the interference audio may include adjusting the interference audio or additional interference audio to the audio portion (e.g., original audio portion) associated with the movie, such that the original audio of the movie may be present to a user via a user device.

FIG. 4 shows an example method. The method 400 may comprise a computer implemented method for providing a service (e.g., a content service, a network service, a communication service, or a combination thereof). A system and/or computing environment, such as the system 100 of FIG. 1 and/or the computing environment of FIG. 6, may be configured to perform the method 400. The method 400 may be performed in connection with the system illustrated in FIG. 1 or the systems illustrated in FIG. 2. Any step or combination of steps of the method 400 may be performed by a computing device, network device, network node, and/or client device, such as any of the devices shown in FIG. 1. Any of the features of the methods of FIG. 3 and FIG. 5 may be combined with any of the features and/or steps of the method 400 of FIG. 4.

At step 402, content comprising an audio portion combined with interference audio may be received. The interference audio may comprise human audible audio that may interfere with at least a portion of the audio portion associated with the content. For example, the interference audio may comprise human audible audio that may interfere with a user hearing at least the portion of the audio portion associated with the content. The human audible range may be any audio frequency between 20 Hertz (Hz) and 20 kilohertz (kHz). In response to receiving the content, one or more of the interference audio or an indication of the interference audio may be received. The content comprising the audio portion combined with interference audio may comprise one or more of: an indication of the interference audio, or a key for demodulating the interference audio.

At step 404, a location within the audio portion may be determined. Determining the location may comprise determining a sample position in an audio sampling set. The location may comprise a first sample position in a first audio sampling set of a first section of the audio portion. Additionally, an additional location may be determined. The additional location may comprise a second sample position in a second audio sampling set of a second section of the audio portion.

At step 406, the interference audio may be removed from the audio portion of the content. The determination of the location may cause the interference to be removed from the audio portion of the content. Causing the interference audio to be removed from the audio portion may comprise removing the interference audio from the audio portion at a sample position. The sample position may be indicated by the location in an audio sampling set. The additional interference audio may be removed from the audio portion of the content. The additional interference audio may be associated with an additional location. The additional interference audio may be different from the interference audio. The additional interference audio may be removed at an additional location within the audio portion of the content. The interference audio or the additional interference audio may be removed based on a key. The key may be sent to an authorized user device. The key may be utilized to demodulate the inference audio and the additional interference audio based on a determination that a user device may have access authorized access to the content.

At step 408, the content comprising the audio portion without the interference audio may be caused to be outputted. The audio portion may be without interference audio. The audio portion may be without the additional interference audio. The location and the additional location associated with the interference audio and the additional interference audio, respectively, may comprise audio signals associated with the content void of interference.

FIG. 5 shows an example method. The method 500 may comprise a computer implemented method for providing a service (e.g., a content service, a network service, a communication service, or a combination thereof). A system and/or computing environment, such as the system 100 of FIG. 1 and/or the computing environment of FIG. 6, may be configured to perform the method 500. The method 500 may be performed in connection with the system illustrated in FIG. 1. Any step or combination of steps of the method 500 may be performed by a computing device, network device, network node, and/or client device, such as any of the devices shown in FIG. 1. Any of the features of the methods of FIG. 3 and FIG. 4 may be combined with any of the features and/or steps of the method 500 of FIG. 5.

At step 502, a request for content comprising an audio portion may be received. The request may be received from a user device associated with a user account. The content may comprise a video portion, an audio portion, or a combination thereof. The user device may be configured to send the request to a computing device, network device, network node, and/or client device, such as any of the devices illustrated in FIG. 1, to receive content comprising an audio portion.

At step 504, based on the request, encoded content may be generated. The encoded content may comprise interference audio mixed with the audio portion. The interference audio may comprise human audible audio that may interfere with a user hearing at least a portion of the audio portion. Generating the encoded content may comprise modulating the interference audio into the audio portion associated with the content. The encoded content may be configured such that a key may be usable to demodulate the interference audio. The key may be any suitable code or waveform associated with the interference audio, or the like. The key may be configured to provide instructions, information, or the like to remove the interference audio from the audio portion of the content. Generating the encoded content may comprise inserting the interference audio at a plurality of locations spaced at intervals in the audio portion associated with the content. Generating the encoded content may comprise determining a location indicating a sample position in an audio sampling set. The determination of the location may indicate a position or time within the content at which the interference audio may begin or where the interference audio may be inserted.

At step 506, the encoded content may be sent. With the encoded content, a key may be sent. The encoded content may comprise interference audio at a plurality of locations spaced at intervals in the audio portion associated with the content. The encoded content may further comprise the key or information associated with the key. In addition or in the alternative, the key may be sent separately (e.g., a separate message) from the encoded content. The key may be configured to provide information on how to remove the interference audio from the content. The key may comprise an indication of the location in the sampling set of where the interference audio begins, an indication of the waveform of the interface audio (e.g., or the waveform itself), or a combination thereof. For example, the key may be the combination of both the location and the indication of the wave form. It is contemplated that the key or information associated with the key may be transmitted (e.g., communicated) to a device (e.g., user device 106 or any other suitable device of FIG. 1) at any suitable point prior to decoding the content. For example, one or more keys could be preloaded onto a user device (e.g., set top box, mobile device) before the user device is sent to the user. The key could be delivered to the user device via a time-expiring or single-use URL only to authorized users. The key could be provided as part of an initial authentication of the user device. The key could be sent in an out-of-band communication.

FIG. 6 depicts a computing device that may be used in various aspects, such as the servers, modules, and/or devices depicted in FIG. 1. With regard to the example architecture of FIG. 1, the one or more content devices (e.g., first content device 102, second content device 105), the network device 104, the user device 106, services device 108, and any devices of network 110 may be each be implemented in an instance of a computing device 600 of FIG. 6. The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 1, FIG. 2, FIG. 3, FIG. 4, and FIG. 5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random-access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 1, FIG. 2, FIG. 3, FIG. 4, and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

The term “or” when used with “one or more of” is used in its inclusive sense (and not in its exclusive sense) so that when used, for example, to connect a list of elements, the term “or” means one, some or all of the elements in the list. The term “or” when used with “at least one of” is used in its inclusive sense (and not in its exclusive sense) so that when used, for example, to connect a list of elements, the term “or” means one, some or all of the elements in the list. For example, the phrases “one or more of A, B, or C” includes any of the following: A, B, C, A and B, A and C, B and C, and A and B and C. Similarly, the phrase “one or more of A, B, and C” includes any of the following: A, B, C, A and B, A and C, B and C, and A and B and C. The phrase “at least one of A, B, or C” includes any of following: A, B, C, A and B, A and C, B and C, and A and B and C. Similarly, the phrase “at least one of A, B, and C” includes any of following: A, B, C, A and B, A and C, B and C, and A and B and C.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some, or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A method comprising:
receiving content comprising an audio portion;
determining a location within the audio portion;
causing interference audio to be inserted, based on the location, into the audio portion of the content, wherein the interference audio comprises human audible audio that interferes with at least a portion of the audio portion; and
sending, to a user device, the content comprising the audio portion having the interference audio, wherein the user device is configured to remove the interference audio before output of the content based on authorization to access the content.

2. The method of claim 1, wherein determining the location comprises determining a sample position in an audio sampling set.

3. The method of claim 1, wherein causing the interference audio to be inserted into the audio portion comprises inserting the interference audio into the audio portion at a sample position, indicated by the location, in an audio sampling set.

4. The method of claim 1, wherein the location comprises a first sample position in a first audio sampling set of a first section of the audio portion, and further comprising determining an additional location and causing the interference audio to be inserted into a second section of the audio portion at a second sample position in a second audio sampling set.

5. The method of claim 1, further comprising sending, to the user device, one or more of the interference audio or an indication of the interference audio.

6. The method of claim 1, further comprising sending, to the user device, one or more of: data comprising an indication of the location, or a key for demodulating the interference audio.

7. The method of claim 1, wherein the interference audio comprises human audio that interferes with a user hearing at least a portion of the audio portion.

8. A method comprising:
receiving a content comprising an audio portion combined with interference audio, wherein the interference audio comprises human audible audio that interferes with at least a portion of the audio portion;
determining a location within the audio portion;
causing the interference audio to be removed, based on the location, from the audio portion of the content; and
causing output of the content comprising the audio portion without the interference audio.

9. The method of claim 8, wherein determining the location comprises determining a sample position in an audio sampling set.

10. The method of claim 8, wherein causing the interference audio to be removed from the audio portion comprises removing the interference audio from the audio portion at a sample position, indicated by the location, in an audio sampling set.

11. The method of claim 1, wherein the location comprises a first sample position in a first audio sampling set of a first section of the audio portion, and further comprising determining an additional location and causing the interference audio to be removed from a second section of the audio portion at a second sample position in a second audio sampling set.

12. The method of claim 8, further comprising receiving one or more of the interference audio or an indication of the interference audio.

13. The method of claim 8, further comprising receiving data comprising one or more of: an indication of the location, or a key for demodulating the interference audio.

14. The method of claim 8, wherein the interference audio comprises human audio that interferes with a user hearing at least a portion of the audio portion.

15. A method comprising:
receiving a request for content comprising an audio portion;
generating, based on the request, encoded content comprising interference audio mixed with the audio portion, wherein the interference audio comprises human audible audio that interferes with at least a portion of the audio portion; and
sending the encoded content and a key for removing the interference audio.

16. The method of claim 15, further comprising determining a location indicating a sample position in an audio sampling set at which the interference audio begins.

17. The method of claim 15, wherein generating the encoded content comprises modulating the interference audio into the audio portion such that the key is usable to demodulate the interference audio.

18. The method of claim 15, wherein generating the encoded content comprising inserting the interference audio at a plurality of locations spaced at intervals in the audio portion.

19. The method of claim 15, further comprising sending one or more of the interference audio or an indication of the interference audio, wherein the interference audio comprises human audio that interferes with a user hearing at least a portion of the audio portion.

20. The method of claim 15, wherein sending the encoded content and the key comprises sending the key in a separate message from the encoded content.
